(19) United States
(12) Patent Application Publication
(10) Pub. No.: US 2008/0030309 A1
(43) Pub. Date: Feb. 7, 2008

(54) System and method for providing information about a medication to a medicine user

(75) Inventor: Daniel James Darrouzet, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/496,326

(22) Filed: Jul. 31, 2006

(51) Int. Cl. G08B 1/00; G08B 13/14

(52) U.S. Cl. 340/309.7; 340/572.8

(57) ABSTRACT

The present invention provides a system and method for providing information about a medication to alert a medicine user to take the medication. It uses an RF-transponder associated with a medicine container. The RF-transponder can be used to enter data on a medication in the medicine container into a display-containing portable electronic device, and when it is time to take medication, the portable electronic device can generate an audible, a visual and/or a physical signal to alert a medicine user, and display information about the medication.

### FIELD OF THE INVENTION

The present invention relates generally to the field of providing information about a medication to a medicine user, and, more particularly, to electronically providing information about a medication to a medicine user.

### BACKGROUND OF THE INVENTION

Patients or other medication-users frequently forget to take medication because: 1) the medicine is for an acute problem and the patient is not used to taking medicine on a regular basis; 2) they take regular medication, but frequently forget; 3) they take many medications and are easily confused if the medicines are to be taken at different times. In addition, patients sometimes may take too much medicine because they forgot that they have already taken the medication. The known solutions are either pill boxes/dispensers or hand written notes.

### SUMMARY OF THE INVENTION

The present invention provides a Medicine Alert using an RF-ID transponder or tag (e.g., on the bottle, box or other medicine container, etc.) to provide information regarding which prescription or over-the-counter medication (e.g., pill, capsule, caplet, powder, liquid, aerosol, gaseous, etc.) and how often the medication should be taken. The patient's display-containing portable electronic device, e.g., cell phone with custom software or other portable medical monitor (Med-Monitor) can be used to read the RF-ID transponder. Information on times to take the medicine and dosage (e.g., number of pills or teaspoons, etc.) can also be entered into Patient's Med-Monitor (e.g., by the RF-ID transponder, doctor, pharmacist, etc.). In addition, the patient may enter additional information (e.g., an exact time to take the medication, frequency and timing of alerts, type of alerts, etc.). Once the patient activates the software in the Med-Monitor (which may be in their cell phone or other portable electronic device, etc.), the Med-Monitor can alert them when it is time to take the next dose of medicine. Information on the patient's usage of medicine can be kept in the patient's Med-Monitor. The RF-ID transponder may remain on the medicine container given to the patient, or may be retained by the pharmacist in certain circumstances (e.g., to reduce costs, in case of tag supply shortages, for older medications, or infrequently prescribed medications, etc.). The tag can be coded by the pharmacist, the pharmacist's supplier or the over-the-counter medicine supplier. The Med-Monitor may also prompt the patient to call the pharmacy or doctor and request a refill, or remind the patient that the over-the-counter medicine may soon be running out.

The following solution can be very easy for the patient to use as follows: (1) the Medicine container RF-ID transponder is placed in close proximity to the Med-Monitor and the Med-Monitor is caused to read information on the medicine; (2) the Med-Monitor is initialized for time when the first dosage is to be taken; (3) the Med-Monitor can then tell the patient when to take the medicine, generally reminding the patient at set intervals; (4) the Med-Monitor can show the history of taking that particular medicine by allowing the patient to ‘click’ that a particular dose has been taken, and thus the history would then be available for later use; and/or (5) the cell phone, reader or other portable electronic device could be carried by the patient, and in emergencies, Emergency Medical Technicians (EMT) or doctors could have a good idea of what the patient is taking as well as when they had taken what medications and approximately how long ago the patient had done so. Thus the present invention can help manage medication taken by patient and provide a record when needed.

With the many medications being taken today it can be difficult to juggle the type and timing of the different medications. For a medicine user who does not routinely take medication, it may be very important to remind the patient. For the chronic users, it can allow the patient to manage a variety of medications with less effort. Further, with RF-ID transponders attached to medicine containers, the Med-Monitor can identify which of a multiple-medicine user's medicine containers contains the proper medication to be taken at the time (without having to read possibly small print and technical medication name on the container). The user can also check the Med-Monitor to see when they last took a medication and how long before they can take another dose. This feature is useful for over-the-counter medicine or pain medicine or users that have memory problems. Thus this method and system can not only tell the user when to take the medication but can help the user take the right medication.

The pharmacist may have the software and hardware to load an RF-ID transponder with correct info. At least some of the information may be loaded by the pharmacist's supplier. Having appropriate software in a cell phone may be convenient for some medicine users, but a Med Monitor (a separate device for those for whom cell phones are much less relevant, e.g., elderly who may do not use cell phones regularly, etc.) may be more convenient for other medicine users.

The present invention may be a method of providing information about a medication to a medicine user by using a RF-transponder to enter medicine data relating to medication in a medicine container into a display-containing portable electronic device, entering information concerning at least one time for the medicine user to take the medication into the portable electronic device, using the portable electronic device to generate at least one of an audible alert signal, a visual alert signal and a physical signal to alert the medicine user to take the medication, and displaying information on the medication to be taken, on the display.

In some embodiments, the medicine user enters an indication that the medicine has been taken into the electronic device to update information stored in the electronic device, whereby information tracking usage of the medication is stored in the electronic device. The electronic device may contain information on more than one medication and generates alert signals for the more than one medication. The electronic device may have a “remind-me-later” input that stops the alert signal and schedules a later alert signal.

Reordering information on a prescription may be in data entered from the RF-transponder so that the electronic device alerts the user with a reminder to reorder the prescription. When the electronic device is a cell phone, the cell phone may be used to reorder and to provide information on prescriptions being reordered from data stored in the cell phone.

The medicine container may be a pill bottle, a liquid-medicine-containing bottle, a dry-medicine-containing bottle, a spray bottle, an inhaler or other container for medications in aerosol or gaseous-form, etc. The RF-transponder is attached to the medicine container (e.g., top, bottom, side, inside, underneath label, integrated into label, etc.). The medicine container may also be a box containing the same medication in multiple pill bottles or liquid-medicine-containing bottles with the RF-transponder attached to the box.

Entering of information concerning times to take the medication into the portable electronic device may be entered by the RF-transponder, entered by a pharmacist or entered by a doctor. In addition, the user may enter additional information (e.g., an exact time to take the medication, frequency and timing of alerts, type of alerts, etc.). Under certain circumstances, the user may be allowed to modify previously entered information. The RF-transponder is preferably interrogated by the electronic device in a contactless manner and the RF-transponder is preferably not battery powered.

When the electronic device is a cell phone, the cell phone typically provides audible signals (e.g., ring tones, etc.) and/or vibrates to alert the user. When the electronic device is a portable Med-Monitor it preferably provides both audible and visual signals to alert the user. The portable Med-Monitor may also be set to vibrate (physical signal).

The medication may be an over-the-counter medicine (e.g., pill, capsule, caplet, powder, liquid, aerosol, gaseous, etc.), rather than a prescription. The RF-transponder may also be used by a pharmacy or store for inventory control. Preferably, scrolling the display allows display of additional information stored in the electronic device. Moreover, the medication may be a vitamin, mineral supplement, dietary supplement or any other thing taken by the user on a regular basis over a short or long term.

The present invention can also be a system for providing information about a medication to alert a medicine user to take the medication that includes a medicine container, and an RF-transponder attached to the medicine container having data on the medication in the medicine container. The RF-transponder is capable of being read by a display-containing portable electronic device that is capable of generating at least one of an audible signal, a visual signal, a physical signal (i.e., vibrate) to alert a medicine user to take the medication.

In addition, the present invention can be a method of providing information about medication to a medicine user by using a first RF-transponder associated with a first medicine container to enter data on a first medication in the medicine container into a display-containing portable electronic device, entering information on times to take the first medication into the portable electronic device, using a second RF-transponder associated with a second medicine container to enter data on a second medication in the second medicine container into the portable electronic device, entering information on times to take the second medication into the portable electronic device, generating at least one of an audible signal, a visual signal, a physical signal (i.e., vibrate) with the portable electronic device to alert the medicine user to take the first medication and displaying information on the first medication to be taken on the display, and entering an indication that the first medication has been taken into the electronic device to update information stored in the electronic device, and generating at least one of an audible signal, a visual signal, a physical signal (i.e., vibrate) with the portable electronic device to alert the medicine user to take the second medication and displaying information on the second medicine to be taken on the display, and entering an indication that the second medication has been taken into the electronic device to update information stored in the electronic device. Note that this method is applicable to more than two medications.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 shows top and side views of a system for providing information about a medication to alert a medicine user to take the medication, comprising: a medicine container; and an RF-transponder attached to the medicine container having data on the medication in accordance with one embodiment of the present invention;

FIG. 2 shows a cell phone as a display-containing portable electronic device that is capable of generating at least one of an audible signal, a visual signal, a physical signal (i.e., vibrate) to alert a medicine user to take the medication in accordance with one embodiment of the present invention;

FIG. 3 shows a Med-Monitor as a display-containing portable electronic device that is capable of generating at least one of an audible signal, a visual signal, a physical signal (i.e., vibrate) to alert a medicine user to take the medication in accordance with one embodiment of the present invention; and

FIGS. 4A and 4B show flow charts of a method to provide notifications to a medicine user in accordance with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides a system and method for providing information about a medication (e.g., pill, capsule, caplet, powder, liquid, aerosol, gaseous, etc.) to alert a medicine user to take the medication. It uses using an RF-transponder or tag associated with a first medicine container to enter data on a medication in the medicine container into a display-containing portable electronic device, and when it is time to take medication the portable electronic device generates an audible, a visual and/or a physical (i.e., vibrate) signal to alert a medicine user, and displays information about the medication.

In some embodiments, the medicine user enters an indication that the medicine has been taken into the electronic device (e.g., cell phone or Med-Monitor, etc.) to update information stored in the electronic device, e.g., by pushing a button on a Med-Monitor or a key on a cell phone. Generally, the electronic device is a portable medical monitor device, a cell phone, a personal data assistant (PDA), or other portable electronic device commonly carried by the user that has near field communications capability.

The storing of an indication that the medicine has been taken allows tracking usage of the medication stored in the electronic device. The electronic device may contain information on more than one medication and generate alert signals for the more than one medication. Preferably, scrolling the display allows display of additional information stored in the electronic device. A cell phone with a 911 feature could display a message that the phone contains such medical information after a 911 call. The use of the electronic device to provide information to emergency personnel of the one or more medications being used by the user can be especially important.

The electronic device may have a “remind-me-later” input that stops the alert signal and schedules a later alert signal. This may be after a preset interval, or the user may input a specific time. Entering of information concerning times to take the medication into the portable electronic device may be entered by the RF-transponder, entered by a pharmacist, entered by a doctor or entered by the RF-transponder. In addition, the user may enter additional information (e.g., an exact time to take the medication, frequency and timing of alerts, type of alerts, etc.). Under certain circumstances, the user may be allowed to modify previously entered information. The RF-transponder is preferably interrogated by the electronic device in a contactless manner (e.g., near field communications) and the RF-transponder is preferably not battery powered.

When the electronic device is a cell phone, the cell phone is used to reorder the medicine by providing information on the prescription being reordered from data stored in the cell phone. In addition, when the electronic device is a cell phone, the cell phone typically provides audible signals (e.g., ring tone or tones, etc.) and/or visual signals and/or physical signals (i.e., vibrate) to alert the user. When the electronic device is a portable Med-Monitor it preferably provides both audible and visual signals to alert the user. The portable Med-Monitor may also provide physical alerts (i.e., vibrate).

The medicine container may be a pill bottle or liquid-medicine-containing bottle and the RF-transponder may be attached to the pill bottle. The medicine container may be a box containing the same medication in multiple pill bottles or liquid-medicine-containing bottles with the RF-transponder attached to the box. In addition, the RF-ID transponder may be retained by the pharmacist in certain circumstances (e.g., to reduce costs, in case of tag supply shortages, for older medications, or infrequently prescribed medications, etc.). The RF-transponder may also be kept elsewhere, such as on a card kept in a card file, especially if used for over-the-counter medications. An advantage of having the RF-ID transponder attached to the medicine container is that the electronic device can be used to interrogate a RF-transponder attached to a medicine container to identify which prescription or over-the-counter medication is to be taken in response to a specific alert. Thus the sequence might be: (1) an alert; (2) acknowledgement by user of the alert; (3) an RF interrogation to finding the RF-ID transponder of the correct medication for that alert; and (4) the user entering an indication that the second medication has been taken into the electronic device to update information stored in the electronic device (e.g., the user pushing a key to a query on the electronic device display “Has the medication been taken? [1] Yes, [2] No”). Note that this method is applicable to more than two medications.

The medication may be an over-the-counter medicine (e.g., pill, capsule, caplet, powder, liquid, aerosol, gaseous, etc.), rather than a prescription. The RF-transponder may also be used by a pharmacy in inventory control. Moreover, the medication may be a vitamin, mineral supplement, dietary supplement or any other thing taken by the user on a regular basis over a short or long term.

Thus, the present invention can also be a method of providing information about medication to a medicine user by using a first RF-transponder associated with a first medicine container to enter data on a first medication in the medicine container into a display-containing portable electronic device, entering information on times to take the first medication into the portable electronic device, using a second RF-transponder associated with a second medicine container to enter data on a second medication in the second medicine container into the portable electronic device, entering information on times to take the second medication into the portable electronic device, generating at least one of an audible signal, a visual signal and a physical signal (i.e., vibrate) with the portable electronic device to alert the medicine user to take the first medication and displaying information on the first medication to be taken on the display, and entering an indication that the first medication has been taken into the electronic device to update information stored in the electronic device, and generating at least one of an audible signal, a visual signal and a physical signal (i.e., vibrate) with the portable electronic device to alert the medicine user to take the second medication and displaying information on the second medicine to be taken on the display, and entering an indication that the second medication has been taken into the electronic device to update information stored in the electronic device. Note that this method is applicable to more than two medications.

The Med Monitor routine might be as follows: (1) patient picks up prescription; (2) reads RF-ID transponder from pharmacist with patient's cell phone or patient's Med Monitor; (3) sets time to take this set of medicines into patient's Med Monitor; (4) patient's Med Monitor beeps when time to take next medicine; (5) patient scrolls screen to see all info and takes medicine; (6) patient is prompted to re-order; (7) calls pharmacy to reorder; and (8) pharmacy calls to tell that reorder is ready.

Information that is stored in the RF-ID transponder and transferred to the cell phone or Med-Monitor preferably includes at least one or more of the following: (1) identification of medicine, e.g., name of medicine on container; (2) how often to take medicine; (3) how much to take at one time; (4) expiration date of medicine; (5) number of allowable refills, e.g., 0, 1, 2, unlimited; (6) user of the medicine; e.g., husband, wife, child, such that one portable electronic device could remind more than one person in family (could have a different alert for different members of the family); and/or (7) suggested time to take medicine.

The present invention can also be a system for providing information about a medication that includes a display-containing portable electronic device capable of reading an RF-transponder having data on the medication in the medicine container and generating at least one of an audible signal, a visual signal or a physical signal (i.e., vibrate) to alert a medicine user to take the medication. Moreover, one or more portable electronic devices may be communicably coupled to a computer or server to provide large scale monitoring and management. For example, a computer could manage and monitor many medications for a single patient or small amounts of medications for many patients (e.g., a family). Furthermore, the portable electronic device can be may be communicably coupled to one or more monitoring devices (e.g., heart monitor, blood pressure, blood sugar, etc.) to collect relevant data and determine if an event has occurred that requires the patient to take a medication. The portable electronic device can then alert the patient, a family member, the patient's doctor and/or emergency services.

The present invention can also be a system for providing information about a medication to a medicine user that includes a medicine container, an RF-transponder attached to the medicine container having data on the medication in the medicine container, and a display-containing portable electronic device capable of reading the RF-transponder and generating at least one of an audible signal, a visual signal or a physical signal (i.e., vibrate) to alert a medicine user to take the medication.

The RF-ID transponder on medicine containers could also help in other ways, such as identifying medicine left in medicine cabinet and checking on expiration dates. It could also help a pharmacy in checking expiration dates of stock. Note also a battery-less RF-ID transponder avoids problems that might otherwise occur from expired stock with discharged batteries.

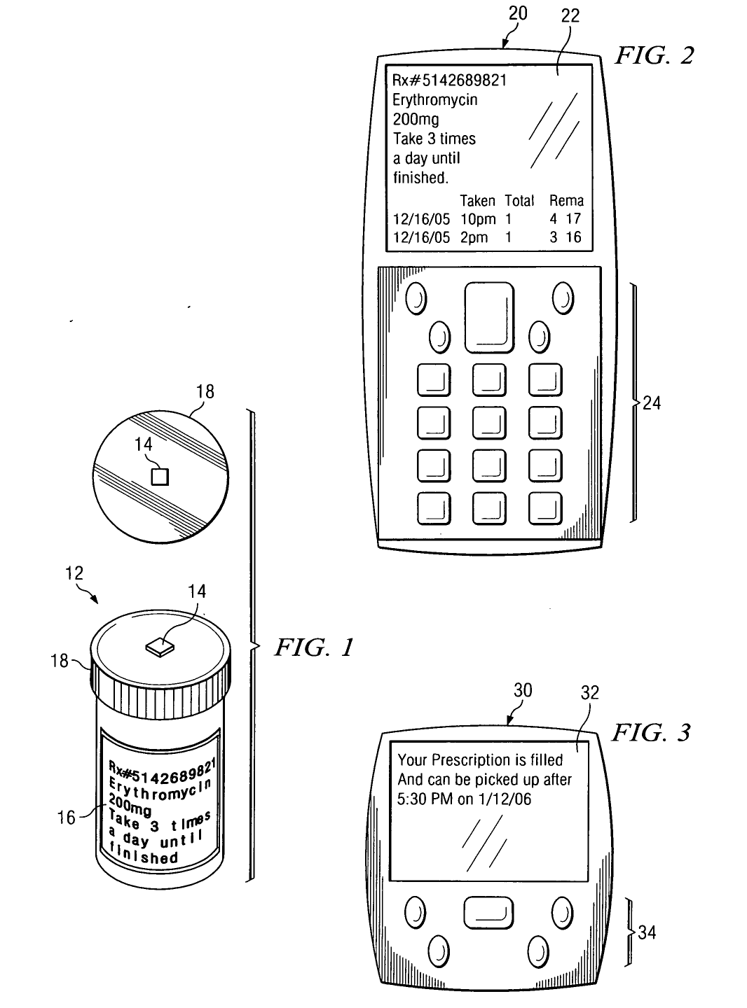

FIG. 1 shows top and side views of a system for providing information about a medication to alert a medicine user to take the medication. A medicine container 12 is shown with an RF-transponder 14 attached in accordance with one embodiment of the present invention. The medicine container 12 can have relatively detailed data on the medication. The RF-transponder or tag 14 attached to medicine container 12 is capable of being read by a display-containing, signal-producing, portable electronic device. Note that the print on medicine container label 16 can be relative difficult for some people to read and the RF-transponder 14 can aid in finding the correct medication from among several medicine containers. The RF-ID transponder is shown on the medicine container top 18, but could alternately be attached elsewhere on the medicine container (e.g., bottom, side, inside, underneath label 16, integrated into label 16, etc.).

The RF-ID transponder 14 can be coded by the medicine manufacturer, the store and/or the pharmacist/doctor. In addition, multiple RF-ID transponders can be used (e.g., general directions or information provided by the medicine manufacturer and specific directions or information provided by the pharmacist). For example, an over-the-counter (OTC) medicine manufacturer could encode a “directions tag” containing recommended dosage (e.g., 2 tablets every 4 hours) and it would remain on the original container of the medication (note: either a separate tag or a combination tag is possible, to track the medication for logistics, quality control and other purposes without the user having access to this information). The “directions tag” for OTC medication is not intended to be altered by anyone and is “burned in” by the OTC manufacturer. The near field communications device on the phone or MED Monitor simply reads the OTC “directions tag” and user applications software (SWu) interprets and offers the user options to help manage taking the medication. For prescription medications, a “pharmaceutical direction tag” (PDT), which is a blank RF-ID tag, is placed on the container as previously described. The pharmacist writes to the RF-ID tag with an RF-ID Reader (which is also has encoder capability as currently available on the market) and “burns in” the PDT for a particular prescription medication similar to the written labels on currently dispensed prescription medications. Additional pharmaceutical software (SWp) would be used link the RF-ID encoder to existing computerized libraries of doctors, drugs, prescribed dosages, etc. that currently produce such written labels. Moreover, SWp would interface with existing software (e.g., patient record keeping software, label printing software, etc.) that is used currently to dispense prescribed medicines. SWp would transfer the key data from the libraries into the blank PDT that the pharmacist attaches to the dispensed medication. Again, the near field communications device on the phone or MED Monitor simply reads the PDT and user applications software (SWu) interprets and offers the user options to help manage taking the medication. SWu would provide the medicine user with options on how to manage and report usage and re-order of the medicines.

FIG. 2 shows one embodiment of the present invention in which a cell phone 20 with software to serve as the display-containing portable electronic device with an audible signal (the display 22 could also flash to provide a visual signal as well) to alert a medicine user to take the medication. A physical signal (i.e., vibrate) may also be provided. The display 22 provides information on the medication, which may be relatively brief, e.g., name or type of medicine and number of pills to be taken, but may be relatively detailed, and may be of a history of medications taken. The normal keys 24 of the cell phone 20 can be used in the implementation of medication functions of the cell phone 20, e.g., loading of medical information and medication times into the cell phone 20, acknowledging the alert, identifying the correct medicine container, entering an indication that the medication has been taken (which also might be prompted by the identification of the correct medicine container), sending prescription refill information, etc.

FIG. 3 shows an embodiment of the present invention in which a Med-Monitor 30 with software to serve as the display-containing portable electronic device with an audible signal and a display 32 that flashes to provide a visual signal to alert a medicine user to take the medication. This electronic device can also be used to interrogate a RF-transponder attached to a medicine container to identify a medication to be taken in response to an alert. Similar to the display in FIG. 2, the display 32 provides information on the medication, and the keys 34 can be used in the implementation of medication functions. Like the cell phone, the Med-Monitor 30 can include a call 911 feature.

Several transponder arrangements have been developed. One such transponder arrangement is described in U.S. Pat. No. 5,053,774 issued to Schuermann et al. on Oct. 1, 1991, incorporated herein by reference. This patent describes a transponder unit which has a low energy requirement and does not need its own power source. Another transponder arrangement is disclosed by Meier et al. in U.S. Pat. No. 5,548,291 issued Aug. 20, 1996, also incorporated herein by reference. In this application, another transponder arrangement which may be updated in a contactless manner subsequent to its manufacture is described.

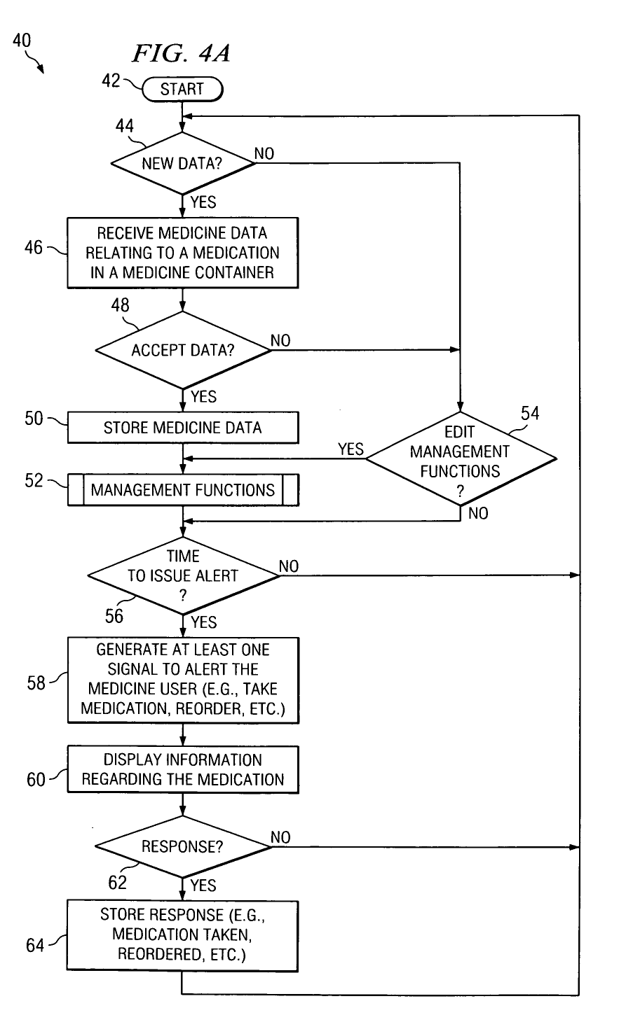

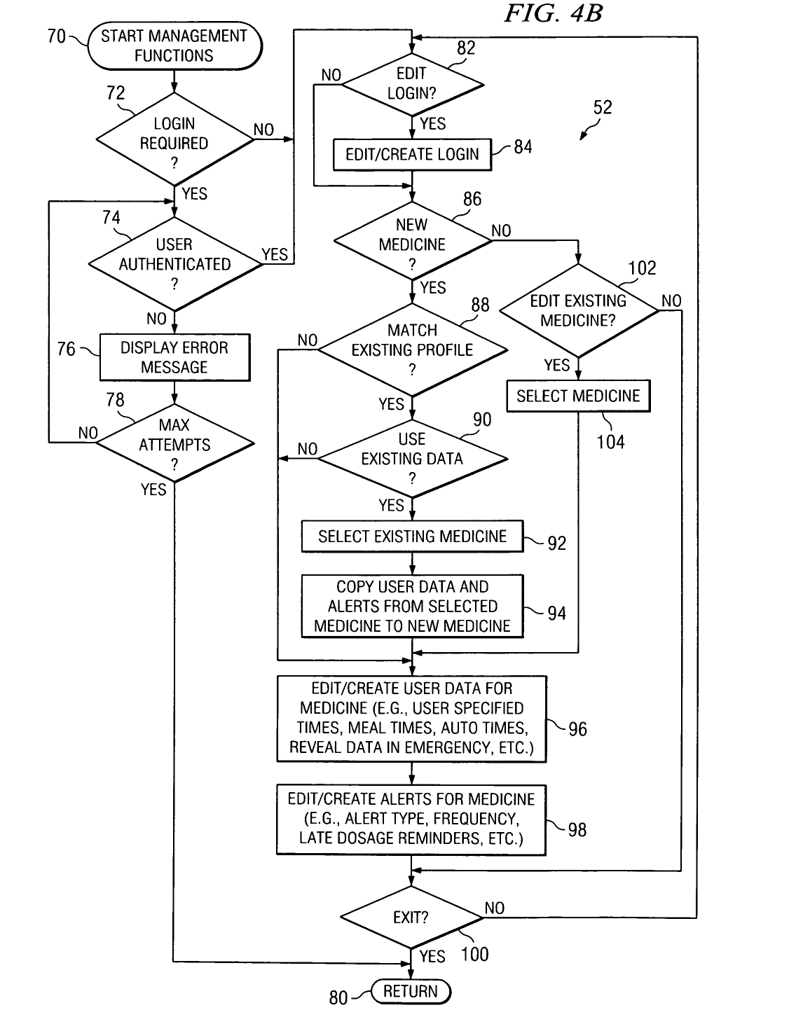

FIGS. 4A and 4B show flow charts of a method 40 to provide notifications to a medicine user in accordance with the present invention. The process begins in block 42. If new data is available, as determined in decision block 44, the medicine data relating to a medication in the medicine container is received in block 46. If the data is accepted (user controlled or automated), as determined in decision block 48, the medicine data is stored in block 50 and the user can perform various management functions in block 52. The management functions (Med Manager) are described in more detail in reference to FIG. 4B. If, however, the data is not accepted, as determined in decision block 48, and the management functions are edited, as determined in decision block 54, the user can perform various management functions in block 52. After the management functions are complete in block 52, or the management functions are not edited, as determined in decision block 54, the device determines whether it is time to issue an alert. If it is time to issue an alert, as determined in decision block 56, at least one signal to alert the medicine user is generated in block 58. As previously discussed, the signal can be audible, visual, physical or a combination thereof. Moreover, the signal can notify the medicine user that it is time to take a particular medication, reorder the medicine or other desirable medical-related prompts. The relevant information regarding the medication that is the subject of the alert is displayed in block 60. If the user responds, as determined in decision block 62, the response is stored in block 64. The response can be an indication that the medicine user has taken the medication, reordered the medication, requested a subsequent notification, etc. Thereafter, or if no response is entered, as determined in decision block 62, or it is not time to issue an alert, as determined in decision block 56, the process loops backs to check for new data (decision block 44) or a time to issue an alert (decision block 56) as previously described.

Now referring to FIG. 4B, the management functions are started in block 70. If a login is required, as determined in decision block 72, a standard user authentication procedure is performed (e.g., user ID, password, PIN, etc.). If the user is not authenticated, as determined in decision block 74, an error message is displayed in block 76. If a maximum number of login attempts have occurred, as determined in decision block 78, the process returns to block 52 (FIG. 4A) and continues as previously described. If, however, a maximum number of login attempts have not occurred, as determined in decision block 78, the process repeats the authentication process as previously described in decision block 74. If, however, a login is not required, as determined in decision block 72, or the user is authenticated, as determined in decision block 74, the user can edit the login information (decision block 82), enter data pertaining to a new medicine stored in block 50 (FIG. 4A) (decision block 86), edit data pertaining to an existing medicine (decision block 102), or exit the management functions (decision block 100). These choices are typically presented in a management menu that allows the user to pick any action in any order, as indicated by the looping process from decision block 100 back to decision block 82. If the user selects to edit the login information, as determined in decision block 82, the user edits or creates the login information in block 84 and is then returned back to the management menu. The user can decide to enter data pertaining to a new medicine stored in block 50 (FIG. 4A), as determined in decision block 86, and then check to see if an existing medicine profile matches the new medicine, as determined in decision block 88. If the user decides to use data from an existing medicine profile, as determined in decision block 90, the user selects the existing medicine block 92 and copies the user data and alerts from the selected medicine to the new medicine in block 94. Thereafter, or if the user decides not to check to see if an existing medicine profile matches the new medicine, as determined in decision block 88, or the use decides not to use data from an existing medicine profile, as determined in decision block 90, the user edits or creates user data for the medicine in block 96. The user data may include user specified times to take the medicine, whether to take the medicine at meals (especially if the PDT indicates this), automatic or default time determined by the software (software suggests best time based on medical information from the medicine itself), whether or not to reveal information about the medicine and/or the user in the event of an emergency to a family member or medical practitioner (e.g., EMT personnel, doctor, nurse, etc.). The user can then edit or create alerts for the medicine in block 98. The alert data may include the type of alert (visual, audible, physical, combination, etc.), the frequency of the alert, the frequency and type of late dosage reminders (e.g., one in five minutes, ever fifteen minutes until taken, never, etc.). Thereafter, the user is returned to the management menu. If the user selects to edit data pertaining to an existing medicine, as determined in decision block 102, the medicine is selected in block 104, the user data is edited in block 96, the alerts are edited in block 98 and the user is then returned to the management menu. If the user selects to exit the management functions, as determined in decision block 100, the process returns to block 52 (FIG. 4A) and continues as previously described.

Although preferred embodiments of the present invention have been described in detail, it will be understood by those skilled in the art that various modifications can be made therein without departing from the spirit and scope of the invention as set forth in the appended claims.

What is claimed is:

1. A method of providing information about a medication to a medicine user, comprising the steps of:
using a RF-transponder to enter medicine data relating to the medication in a medicine container into a display-containing portable electronic device;
entering information concerning at least one time for the medicine user to take the medication into the portable electronic device;
using the portable electronic device to generate at least one signal to alert the medicine user to take the medication; and
displaying information on the medication to be taken on the display.

2. The method of claim 1, wherein the medicine user enters an indication that the medicine has been taken into the portable electronic device to update information stored in the portable electronic device, whereby information tracking usage of the medication is stored in the portable electronic device.

3. The method of claim 1, wherein the portable electronic device contains information on more than one medication and generates alert signals for the more than one medication.

4. The method of claim 1, wherein reordering information on a prescription is in data entered from the RF-transponder and the portable electronic device alerts the user with a reminder to reorder the prescription.

5. The method of claim 1, wherein the portable electronic device is a portable medical monitor device, a cell phone, a PDA or a combination thereof.

6. The method of claim 1, wherein the portable electronic device is a cell phone and the cell phone is used to reorder the medication by providing information on a prescription being reordered from data stored in the cell phone.

7. The method of claim 1, wherein the portable electronic device had a “remind-me-later” input that stops the alert signal and schedules a later alert signal.

8. The method of claim 1, wherein the medicine container comprises a pill bottle, a liquid-medicine-containing bottle, a dry-medicine-containing bottle, a spray bottle, an inhaler, an aerosol dispenser, a gaseous-medication dispenser or a box containing the same medication in multiple pill bottles or liquid-medicine-containing bottles.

9. The method of claim 1, wherein the RF-transponder is attached to a top, a bottom, a side, inside, underneath a label or integrated into the label of the medicine container.

10. The method of claim 1, wherein the RF-transponder is interrogated by the portable electronic device in a contactless manner and the RF-transponder is not battery powered.

11. The method of claim 1, wherein the entering information concerning times to take the medication into the portable electronic device is entered by the RF-transponder, entered by a pharmacist, entered by a doctor, entered by a user, modified by the user or a combination thereof.

12. The method of claim 1, wherein the portable electronic device is used to interrogate a RF-transponder attached to a medicine container to identify a medication to be taken in response to an alert.

13. The method of claim 1, wherein the portable electronic device provides information to emergency personnel of medication being used by the user.

14. The method of claim 1, wherein the medication comprises a prescription medicine, an over-the-counter medicine, a vitamin, a mineral supplement, a dietary supplement, or a combination thereof

15. The method of claim 1, wherein the medication comprises a pill, a capsule, a caplet, a powder, a liquid, an aerosol or a gas.

16. The method of claim 1, wherein the RF-transponder is used by a pharmacy or store in inventory control.

17. The method of claim 1, wherein the at least one signal comprises of an audible signal, a visual signal, a physical signal or a combination thereof.

18. The method of claim 1, wherein scrolling the display allows display of additional information stored in the portable electronic device.

19. A system for providing information about a medication to alert a medicine user to take the medication, comprising:
a medicine container; and
an RF-transponder attached to the medicine container having data on the medication in the medicine container, the RF-transponder being capable of being read by a display-containing portable electronic device that is capable of generating at least one signal to alert a medicine user to take the medication.

20. A method of providing information about medication to a medicine user, comprising the steps of:
using a first RF-transponder associated with a first medicine container to enter data on a first medication in the medicine container into a display-containing portable electronic device;
entering information on times to take the first medication into the portable electronic device;
using a second RF-transponder associated with a second medicine container to enter data on a second medication in the second medicine container into the portable electronic device;
entering information on times to take the second medication into the portable electronic device;
generating at least one signal with the portable electronic device to alert the medicine user to take the first medication and displaying information on the first medication to be taken on the display, and entering an indication that the first medication has been taken into the portable electronic device to update information stored in the portable electronic device; and
generating at least one signal with the portable electronic device to alert the medicine user to take the second medication and displaying information on the second medicine to be taken on the display, and entering an indication that the second medication has been taken into the portable electronic device to update information stored in the portable electronic device.
